(19) United States
(12) Patent Application Publication
(10) Pub. No.: US 2009/0118897 A1
(43) Pub. Date: May 7, 2009

(54) Method for damage forecast of components of a motor vehicle

(75) Inventor: Peter Schoeggl, Hitzendorf (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 12/289,603

(22) Filed: Oct. 30, 2008

(30) Foreign Application Priority Data
Nov. 2, 2007 (AT) A 1771/2007

(51) Int. Cl. G01M 17/00

(52) U.S. Cl. 701/29

(57) ABSTRACT

The invention relates to a method for forecasting the damage of components of a motor vehicle, comprising the following steps:
Providing a damage model for at least one component;
detecting the loading of the component;
determining the loading and damaging of the component along a damage distance and/or over a damage period;
determining a reference distance and/or reference period on the basis of the determined loading of and/or damage to the component;
comparing the damage distance and/or the damage period with the reference distance or reference period;
determining an acceleration factor from the damage distance and reference distance or damage period and reference period.

The invention relates to a method for damage forecast of components of a motor vehicle.

A vehicle with a management system is known from JP 2003-345421 A which provides that components are monitored by a sensor system and are sent to a central computer in the event of a problem. The central computer identifies the field of the problem and determines the damage caused to the parts of the system and makes a forecast on the further damage characteristics and service life. The vehicle's user is informed about the results of this evaluation. Moreover, various information is sent to the vendor and stored in a database. As a result, recommendations for inspections and service appointments are given to the user prior to the occurrence of any serious damage. The disadvantage is that the information is sent to a central computer which initiates further evaluation. Real-time evaluation of the measured data can thus not be guaranteed, so that in the extreme case damage may already have occurred before there is an evaluation by the central computer. There is a further disadvantage in that no damage database is used and no calibration with statistical damage frequency is made.

An apparatus for estimating the service life of technical components is known from DE 102 57 793 A. The forecast on the service life to be expected is made on the basis of a damage model, with the system loads being considered through a respective sensor system on the basis of local component-specific loads. Time curves of local component loads are determined in this proposal by temporal integration of the model behavior under the influence of the complete set of time-dependent system loads. These loads on the components can be present in the form of a temporal progression of local reaction forces, tensions and expansions on the chosen component. The evaluation of the component damage accumulated as a result of the loads to which the component was subjected occurs in the environment of an analysis of operational stability by evaluating the time progressions of the loads in a damage accumulation calculation.

Any imprecision in the damage models or imprecise input data can lead to noteworthy deviations in the forecasts of the actual values of the remaining service life over time, so that such approaches are subject to a relatively high amount of imprecision.

Moreover, it is required in racing sports to adapt components in an extremely precise way to the expected loads. It is thus necessary for example in order to avoid disadvantages that an engine can be used for a specific number of races without any defects. The optimal design of the individual components of the engine is given when the service life of the individual components has decreased to zero after the last lap. It has been noticed that it is not sufficient to provide a specific number of operating hours or mileage in the design of the individual components, because the components are loaded in a very different manner depending on the operating states.

It is the object of the invention to avoid such disadvantages and enable in the simplest possible way an early and reliable recognition of damage and/or a forecast on the residual service life.

This is achieved in accordance with the invention by the following steps:
Providing a damage model for at least one component;
detecting the loading of the component;
determining the loading and damaging of the component along a damage distance and/or over a damage period;
determining a reference distance and/or reference period on the basis of the determined loading of and/or damage to the component;
comparing the damage distance and/or the damage period with the reference distance or reference period;
determining an acceleration factor from the damage distance and reference distance or damage period and reference period.

As in the state of the art as cited above, a damage model is used in order to draw conclusions on a remaining service life or remaining distance from the load on the component. In contrast to the state of the art, there is a continuous adjustment and optimization of the model on the basis of the experience gained during operation.

It is preferably provided that the damage percentages of all damage distances and/or damage periods of the components are added up and are compared with a maximum value stored in a database. It is especially advantageous when damage to the component is determined upon reaching the maximum value.

The method in accordance with the invention makes it possible to take into account the individual loading of the individual components in a reasonable way, as also individual critical places of an individual component, depending on the operating conditions. Damage to a connecting rod at high speeds is considerably more critical than at lower speeds. However, other parameters such as the engine temperature or the load also play an important role.

In an especially preferred way, a prognosis on the residual service life of a component or an entire system can be made with the method in accordance with the invention in a further step. Depending on the needs, the residual service life can be a time period in the actual sense or a residual distance until the expected failure. The relevant aspect is that the residual life expectancy must always be regarded with reference to a defined loading. As a result, statements are possible for example during a race, such as: if the manner of driving remains the same like in the last five laps, component x has a residual service life of 7.2 laps.

A reliable forecast on the progression of further damage can be made when the residual service life of the component is estimated from the difference to the maximum value.

It is further provided within the scope of the invention that the residual service life is determined on the basis of at least one service life model stored in a database.

The relevant aspect is that the damage database of the system is continually updated, so that the latest statistical information can be used in the evaluation of the damage and for the forecast of the residual service life. The system is thus designed to be self-learning.

One important property of the method is that there is an online damage calculation. Data reprocessing is thus not necessary. The state of the components can be evaluated in real time and forecasts on the further damaging can be made. Current loading can already be recognized during a test drive.

A subsequent simulation is thus also possible in order to obtain indications for the fine-tuning of the system.

In a preferred embodiment of the invention it is possible that the loading of the component is obtained at least partly on the basis of simulation data. This allows making statements on a component for example which already has a certain loading history. It is assumed that this component will be used in a future race, from which there are assumptions on the expected progress. It is simultaneously also possible to examine a new component exclusively with the help of simulations in order to forecast the expected damage or residual service life.

A further especially preferred embodiment of the method in accordance with the invention provides that as a result of a predetermined required residual service life or residual distance a parameter which is relevant for the loading of the component is calculated. If it is seen during a race for example that will still cover 30 laps that under the given conditions the expected residual service life of a component will only be 25 laps, respective measures can be set in order to reduce the likelihood of a failure. The maximum engine speed can be reduced accordingly in order to raise the residual service life to the required value. In addition to maximum engine sped, complex settings can also be understood as relevant parameters in the above sense, which means that an alternative engine characteristic map can be activated which is less strenuous for the critical component.

The invention is now explained below in closer detail by reference to the embodiments shown in the drawings, wherein:

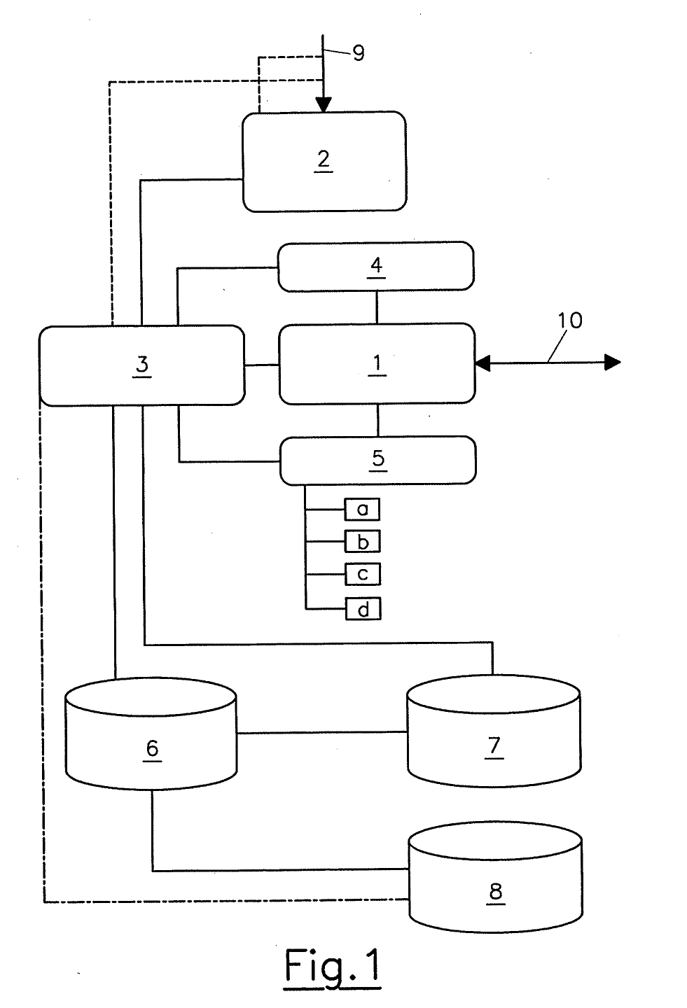

FIG. 1 shows a principal diagram of the method in accordance with the invention;

FIG. 2 shows the damage of a component entered over the engine load and engine speed;

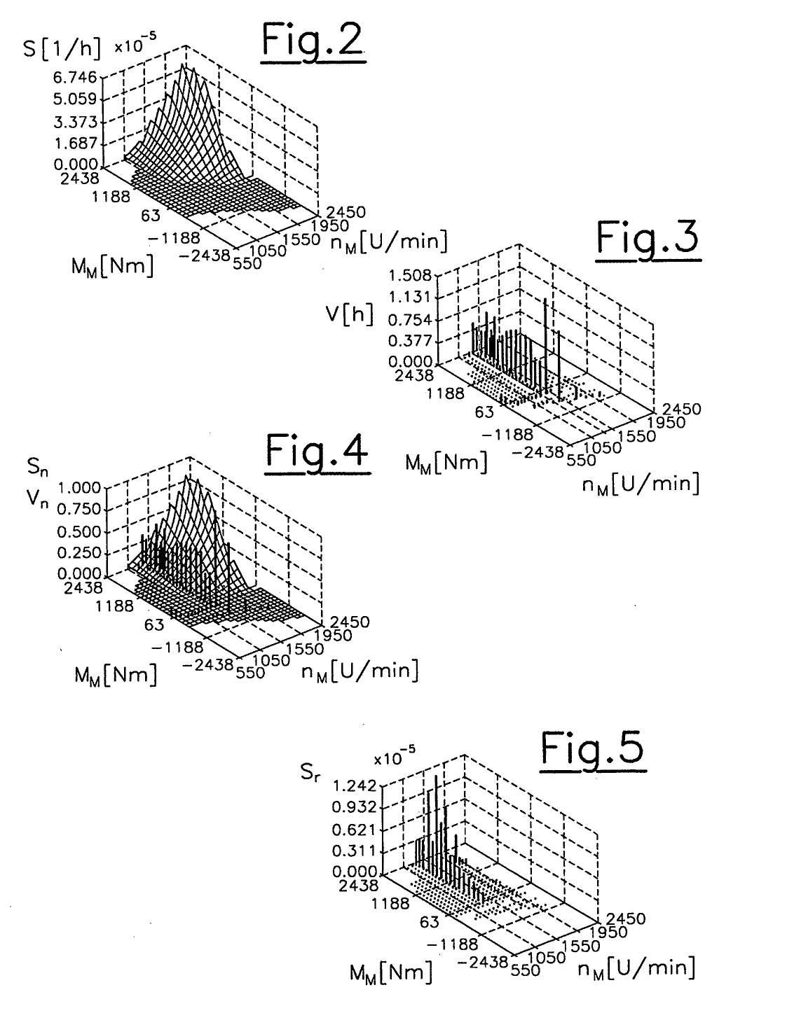

FIG. 3 shows the dwell time for this component in the engine characteristic map;

FIG. 4 shows the normalized damaging of the component and the dwell time in the engine characteristic map, and

FIG. 5 shows the calculated damaging for this component in the engine characteristic map.

The system for damage forecast comprises the following components:
Transmission unit 1,
Measuring system and data logger 2,
Evaluation software 3,
Data archive 4,
Display module 5 for the driver,
Service life models 6,
Damage models 7 and
Service life database 8

Relevant components of the vehicle are monitored continuously or discontinuously via the vehicle's own diagnostic sensor device 9. The data of said diagnostic sensor device 9 are supplied to the measuring system 2 and the evaluation software 3. At the same time with the state of the component, the actual time of use and distance of use of the component is detected. Data archive 4 contains reference distances and reference periods until the occurrence of a damage for each component to be monitored. If damage for a component is determined, the evaluation software 3 compares the damage distance or the damage period until the occurrence of this damage for the respective component with a reference distance or the reference period for this damage in the data archive 4. An acceleration factor is determined on the basis of the deviation between damage distance and reference distance and the damage period and reference period, which factor states whether the damage occurred before or after the statistically determined reference distance or reference period. An update of the data archive 4 can be made via the transmission unit 1. It is further possible to perform an update for failed or defective data and to send the status of the measurement evaluation to a central computer. The data quantities to be transferred are low due to the evaluations made on board of the vehicle. The relevant aspect is that the method for damage forecast can be continued uninterrupted even in the case of a failure of the radio signal 10.

The damage percentages of all damage distances or damage periods of the component are added up and compared with a maximum value stored in the database 4. Upon reaching this maximum value, damage to the component is determined. On the other hand, the remaining service life of the component can be estimated from the difference to the maximum value. More precise results can be obtained when the residual service life is determined on the basis of a service life model 6 saved to a database 8. It is especially advantageous when the service life models 6 are linked with damage models 7.

The display module 6 shows the driver information on

a) current damage or a service life reserve;

b) forecasts of expected damage (acceleration factor);

c) ratio between planned/actual damage, and

d) recommendations for further driving mode for reaching the goal.

The information on current damage can be provided in an optical, acoustic or tactile manner.

The method will be explained below on the basis of a concrete example of a plug-in pump.

The engine torque M_{M} and the engine speed n_{M} are used as sensor signals for monitoring the plug-in pump. The principal service life formula for wear and tear of the cam/roller contact of the plug-in pump can be arranged as a function of the Hertzian contact pressure p₀ of the pump speed n and a constant factor C: L₁₀=f(p₀, n, C), with L₁₀ being the expected service life.

Pump speed n is determined from the engine speed n_{M} and the Hertzian contact pressure p₀ from the respective injection pressures at the associated engine operating point. The injection pressures can be saved in the system in the basic characteristic map.

The current damage to the plug-in pump is obtained from the respective dwell time and the damage at the various engine operating points, which is shown by way of example in FIG. 2. Damage S of the plug-in pump is entered per hour over the engine load L and the engine speed n_{M} (FIG. 2). FIG. 3 shows the dwell time V of the operating points in the characteristic map of the engine over the engine torque M_{M} and the engine speed n_{M}. FIG. 4 shows the normalized damage Sₙ of the plug-in pump per hour and the normalized dwell time Vₙ in the characteristic map of the engine in a diagram. The concrete damage of the plug-in pump is calculated therefrom. FIG. 5 shows the calculated damage Sᵣ for the specific case for a distance after switching off the vehicle over the engine torque M_{M} and the engine speed n_{M}.

The damage distance is then placed in relationship to a reference distance. The mean load collective for the standard user is known as reference collective. It is entered into the system at the beginning of the measurements or even during the measurements.

The ratio of the distance profile to the reference profile results in the acceleration factor.

All damage percentages are added up and compared with a maximum value. Once the maximum value has been reached, the component is damaged and needs to be exchanged. At the same time, the service life reserve can be output under the assumption of a similar load collective up to the time of calculation.

The method in accordance with the invention allows real-time identification of straining and damaging of the overall vehicle during the test operation. Forecasts on the service life can be made relating to the mean load collectives that are probably expected. The results of the damage analysis can be included in damage models, which thus enables self-calibration of the system.

The method allows substantial savings in testing times, test distances/cycles for specific components as well as the overall system can be optimized, and the system behavior over time can be monitored and recorded. The damage models adjusted to the special system can be included in the vehicle's control unit in order to enable more precise forecasts of the service intervals.

A relevant advantage of the method is that the development time for vehicles can be reduced substantially. A further advantage of the method in accordance with the invention is minimizing the failure probability of components by respective measures.

1. A method for forecasting the damage of components of a motor vehicle, comprising the following steps:
providing a damage model for at least one component;
detecting the loading of the component;
determining the loading and damaging of the component along a damage distance and/or over a damage period;
determining a reference distance and/or reference period on the basis of the determined loading of and/or damage to the component;
comparing the damage distance and/or the damage period with the reference distance or reference period; and
determining an acceleration factor from the damage distance and reference distance or damage period and reference period.

2. The method according to claim 1, including determining the expected residual service life or residual distance.

3. The method according to claim 1, including summing the damage percentages of all damage distances and/or damage periods of the component and comparing the sum with a maximum value saved in a database.

4. The method according to claim 3, including determining damage to the component upon reaching the maximum value.

5. The method according to claim, including estimating the remaining service life or remaining distance of the component from the difference to the maximum value.

6. The method according to claim 5, including determining the remaining service life on the basis of at least one service life model stored in a database.

7. The method according to claim 6, including providing the driver with information in an optical, acoustic or tactile manner on a current damage, a service life reserve, a forecast on expected damage, the acceleration factor and/or recommendations on further driving style.

8. The method according to claim 7, including sending current information on damage models, service life models, reference distances, reference periods and maximum damage percentages is sent by way of a wireless connection of the databases.

9. The method according to claim 8, wherein the loading of the component is gained at least partly from simulation data.

10. The method according to claim 9, including calculating a parameter which is relevant for the loading of the component on the basis of a predetermined required remaining service life or remaining distance.
